(19) United States
(12) Patent Application Publication
(10) Pub. No.: US 2024/0133488 A1
(43) Pub. Date: Apr. 25, 2024

(54) PIPELINE HOISTING STRUCTURE AND METHOD

(71) Applicant: Petróleo Brasileiro S.A. - Petrobras, Rio de Janeiro (BR)

(72) Inventor: Andre Luiz Bevilaqua Santana, Macaé (BR)

(73) Assignee: Petróleo Brasileiro S.A. - Petrobras, Rio de Janeiro (BR)

(21) Appl. No.: 18/494,588

(22) Filed: Oct. 24, 2023

(30) Foreign Application Priority Data
Oct. 24, 2022 (BR) BR1020220216126

(51) Int. Cl. F16L 1/12

(52) U.S. Cl. CPC F16L 1/12

(57) ABSTRACT

The present invention relates to a structure and method of hoisting pipelines for subsea connection assisted by a remotely operated vehicle, ROV. Particularly, the present invention describes a pipeline hoisting structure comprising three beams joined together in a U-shape, and two hoisting systems, each being coupled to one of the vertical beams of the hoisting structure.

### CROSS-REFERENCE TO RELATED APPLICATION

This application claims, under 35 U.S.C. 119(a), priority to and the benefit of Brazilian Patent Application No. 10 2022 021612 6, filed Oct. 25, 2022, which is incorporated by reference herein in its entirety.

### FIELD OF THE INVENTION

The present invention is applied in the field of assembly, replacement or repair of subsea pipes or pipelines and, more specifically, is addressed to operations requiring controlled hoisting of pipelines, mainly in subsea connection activities with a remotely operated vehicle (“Remotely Operated Vehicle”—ROV).

### BACKGROUNDS OF THE INVENTION

In some industries with offshore work, such as, for example, the oil and gas industry, pipelines located on the seabed require specialized equipment and procedures for connecting, repairing or replacing the same. For such procedures to occur appropriately and safely, without damaging operators or equipment, it is essential that there is stability in the pipeline hoisting process.

During maneuvers to connect subsea pipelines with the aid of a remotely operated vehicle (ROV), for example, it is customary to use a crane positioned on the vessel itself with the aim of improving the alignment of the flanges located at the ends of the pipelines and allow the mounting of the spikes and/or definitive cases in the connection.

However, the use of the crane of the vessels, in addition to being complex, is subject to climatic and sea conditions that can impose high vibrations on the crane cable. In other words, for the process to be carried out properly, it is often necessary to fully attenuate the relative movements of the crane cable through a heave compensation system.

Still, there are situations in which sea conditions are extremely bad and using the vessel's crane, even with a heave movement compensator, makes the operation unfeasible. In these cases, the waiting time for sea conditions to become favorable for the use of the crane compromises the process.

Furthermore, there is a risk associated with failure of the crane, which may become detached during the maneuver of the subsea pipelines due to the influence of the relative movements of the vessel, causing the pipelines that are being interconnected to be dragged and, consequently, damaging the structure of the same.

As an alternative to cranes positioned on the vessels for maneuvering subsea pipelines, there are currently subsea hoisting systems, where a structure is placed over one of the pipelines to be connected.

However, such structures present little safety as they only provide a load hoisting system that depends on the combined and controlled movements of a set of pistons to move vertically and laterally. Accordingly, if any of the elements that make up the hoisting system fails, the structure needs to be taken to the surface for repair or maintenance.

Additionally, due to the number of transverse bars and pistons in the structure, the central space for manipulating the pipelines ends up being reduced and the weight of the structure is also increased, further increasing the risk of damage during the process.

Accordingly, there is a need of developing a simple and effective solution for pipeline hoisting structures, which does not compromise the service execution time and which allows the connection or manipulation of subsea pipelines with the aid of an ROV, ensuring operator safety and pipeline integrity by providing more effective backup hoisting and load transmission systems.

### STATE OF THE ART

The search for the history of the invention in question led to some documents that disclose matters within the technological field of the present invention.

Document U.S. Pat. No. 4,028,903 describes a method and apparatus for laterally maneuvering the ends of pipes resting on the seabed under a body of water. The method includes mounting a first support structure adjacent to one end of the pipe and supporting the first structure on the seabed. A connecting means is fixed between the pipe and the first support structure, and, next, the adjacent pipe is lifted by applying a lifting force to the connecting means. A second separate support structure is mounted adjacent to the other of said pipelines and with the second structure being supported on the seabed. Another connecting means is fixed between the other pipe and the second support element and the other pipe is hoisted by applying a lifting force to the other connecting means. Next, with both ends of the pipe thus cantilevered, the ends of the pipe are moved laterally and vertically relative to the supporting structure until the ends of the pipe are placed in positions where their axes generally intersect. However, the set of hoisting devices proposed by the aforementioned document does not provide backup hoisting systems, so that any failure in one of its vertical lateral cylinders, or even in the horizontal cylinder, would result in severe damage to the pipes or even a considerable time for take the structure to the surface and promote repair. Furthermore, the cylinder or transverse beam that is hoisted through the joint action of the vertical cylinders at the ends of the element reduces the structure working space and increases the weight of the assembly, making the connection and maneuvering of the pipelines difficult.

With respect to document U.S. Pat. No. 4,109,480, there is disclosed a system of subsea cranes suitable for moving pipes, fittings, tools and machines on the seabed, by divers, and with simple articulated carrying crossbeams, with hydraulic drive means and controls, and possible balloon assistance and means for humping and bending, coupling, and repairing pipelines and machinery under water. However, said document describes a structure with a beam supported at its two ends by different cylinders, so that the movement of both cylinders needs to be mutually supportive so that the beam is hoisted together with the pipe. If one of the cylinders fails, the weight of the structure with the pipe may tilt to one side and thus damage the tubing and delay the procedure. In addition, the positioning of the cross member means less space for movement in the center of the structure.

Furthermore, document U.S. Pat. No. 6,290,431 describes a diverless process for deriving a pressurized subsea pipeline, without removing the pipeline from service. This diverless process uses special fixing equipment, threading equipment and remotely operated vehicles to operate in water depths beyond those accessible to divers. However, the pipeline hoisting mechanisms proposed in this document fail to disclose or suggest effective load transmission systems, which leave a larger movement space in the center of the structure. Furthermore, such a document also does not suggest a backup or redundant hoisting system, capable of being activated in case of failure and thus avoiding damage to the structure and increased time to perform the service.

### BRIEF DESCRIPTION OF THE INVENTION

The present invention pertains to the field of assembly, replacement or repair of subsea pipes or pipelines and, more specifically, refers to a structure and a method of hoisting pipelines for subsea connection assisted by a remotely operated vehicle, ROV.

Accordingly, it is one of the objectives of the present invention to provide a gantry-shaped structure for hoisting pipelines in diverless type operations, wherein said structure can be previously launched over one of the pipelines to be connected and then driven by means of a set for subsea hydraulic connection (“hot stab”) installed thereon and actuated by an ROV to hoist the pipeline, regardless of sea conditions.

In this way, the present invention provides a pipeline hoisting structure with a backup or redundant hoisting system, arranged on one side of the structure, and which, in the event of failure of the main system, can be operated by the ROV during the pipeline hoisting maneuver, without the need of bringing the structure to the surface to carry out maintenance or repairs.

In addition, the present invention further provides a compact pipeline hoisting structure for subsea connection with an effective load transmission system, capable of operating by means of a hydraulic cylinder that transmits linear movement to a set of steel cable and pulleys, leaving the center of the structure free for better movement of the pipeline.

Finally, the pipeline hoisting structure of the present invention further allows, due to its compact constructive form, the services of opening dirty lines and manipulating pipelines in a controlled manner, with auxiliary containment systems (hoods).

Accordingly, the advantages and objectives mentioned above are achieved by the present invention by providing a pipeline hoisting structure comprising three beams joined together in a U-shape, and two hoisting systems, each being coupled to one of the vertical beams of the hoisting structure.

Additionally, the pipeline hoisting method of the present invention comprises: driving a drive receptacle associated with a main hoisting system to vertically move a hydraulic cylinder; transmitting the load and movement through a hoisting steel cable attached to the cylinder at one of its ends and passing through a set of steering pulleys; and hoisting the pipeline by means of a belt wrapped around the pipeline and connected to a winch arranged at the end of the steel cable.

### BRIEF DESCRIPTION OF THE FIGURES

The brief description above, as well as the detailed description below, of the preferred embodiments of the invention in question, will be better understood when read together with the attached drawings. For the purpose of illustrating the present invention, embodiments thereof are shown in the drawings. It must be understood, however, that the invention in question is not limited only to the precise arrangements and instruments as shown.

Thus, the present invention will be described below with reference to typical embodiments thereof and also with reference to the attached drawings, in which:

FIG. 1 shows a perspective view of a pipeline hoisting structure, according to an exemplary configuration of the present invention.

FIG. 2 presents a perspective view of a pipeline hoisting structure, according to another exemplary configuration of the present invention.

FIG. 3 presents in detail a connection region between an end of a hoisting steel cable and a hydraulic cylinder fixing element, according to an exemplary configuration of the present invention.

FIG. 4 shows in detail a connection region between a steering pulley and a horizontal beam of a pipeline hoisting structure, according to an exemplary configuration of the present invention.

### DETAILED DESCRIPTION OF THE INVENTION

There follows a reference made in detail to the preferred embodiments of the present invention illustrated in the attached drawings. Whenever possible, the same or similar reference numbers will be used throughout the drawings to refer to the same or similar features. It should be noted that the drawings are in simplified form and are not drawn at a precise scale, so slight variations are anticipated.

The present invention relates to a structure for hoisting pipelines in subsea connections of the diverless type and its associated method of operation. Furthermore, according to the embodiments of the present invention, the hoisting structure was developed with the objective of meeting any demand in which it is necessary to hoist subsea pipelines, such as, for example, to improve the alignment of flanges and allow the assembly of spikes and/or definitive cases in connection operations between pipelines.

Furthermore, the hoisting structure of the present invention can be used regardless of sea conditions, as it is previously launched over the pipeline to be connected and, when necessary and regardless of sea conditions, a remotely operated vehicle, ROV, through a hydraulic connection system, “hot stab”, installed in the structure, can act in a controlled manner and precisely hoist the pipeline to continue the assembly of the spikes and/or definitive cases.

Therefore, the present invention can be applied in operations requiring controlled pipeline hoisting, mainly, but not limited to subsea connection activities with ROV.

It is worth to highlight that the pipeline hoisting operation provided with the structure that the present invention discloses optimizes waiting time for good sea conditions, as it is necessary, for example, for the use of vessel cranes in alignment operations of flanges for pipeline connection. Thus, the present invention also provides optimization of the vessel costs in this maneuver.

In addition, there is a risk of disarming or failure of the vessel crane during the maneuver of hoisting the pipeline for connection, as it is subject to the influence of the relative movements of the vessel, which could cause the pipelines being interconnected to be dragged, and, consequently, possible damage to the same. With the hoisting structure disclosed by the present invention, this risk of dragging or damage to the pipelines is non-existent, since the structure is not connected to the vessel and acts independently, with the operation being completely controlled by the ROV, precisely, via hot stab system of the hoisting structure itself.

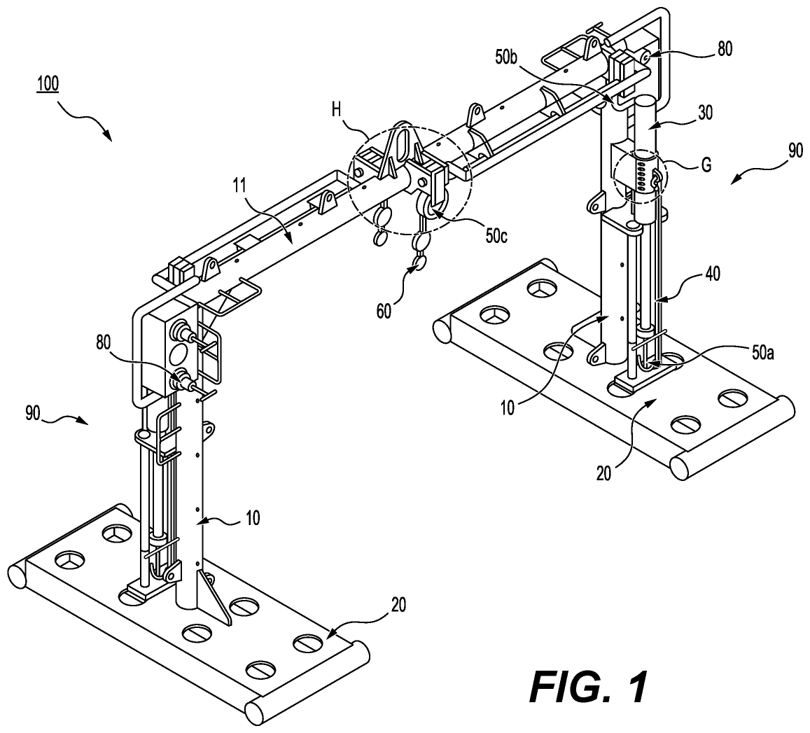

Thus, reference is made to FIG. 1, which provides a representation of the pipeline hoisting structure according to an embodiment of the present invention.

The hoisting structure 100 comprises three metal beams joined together in a “U” shape, wherein two beams 10 extend vertically upwards and connect to the ends of a beam 11 horizontally arranged in the upper portion of the hoisting structure 100. Furthermore, according to an embodiment of the present invention, each of the vertical beams 10 is connected, at its lower end, to a fixing shoe 20 that provides support and stability to the metallic structure 100 on the seabed.

In addition, according to embodiments of the present invention, the hoisting structure 100 has two hoisting systems 90, each being coupled to one of the vertical beams 10 of the structure 100 and acting independently in relation to each other. In this configuration, one of the hoisting systems 90 coupled to a vertical beam 10 acts as the main, or titular, hoisting system, whereas the other hoisting system 90, coupled to the opposite vertical beam, acts as the secondary, or backup, hoisting system. It is worth to highlight that both hoisting systems 90 have the same components and operate according to the same operating principle.

For ease of description, the hoisting system 90 coupled to the right vertical beam 10 will be referred to as the main hoisting system, while the hoisting system 90 coupled to the left vertical beam 10 will be referred to as the secondary hoisting system. However, as it should be noted, this configuration is not limiting, so that the main hoisting system can be considered as the system coupled to the left vertical beam 10, and the secondary hoisting system can be considered as the system coupled to the right vertical beam 10, without deviating from the objectives of the present invention and in accordance with the convenience of the operation.

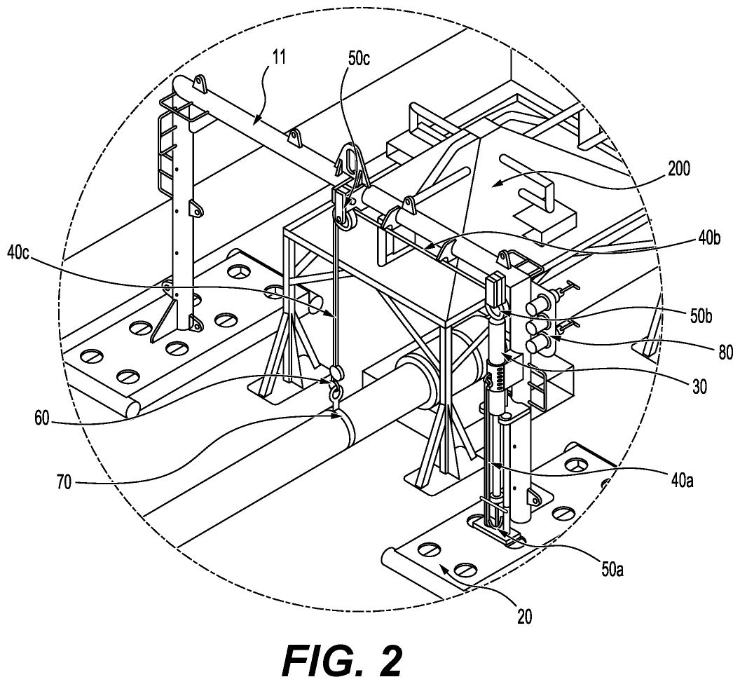

In addition, as detailed in FIGS. 1 and 2, each hoisting system 90 comprises a hydraulic cylinder 30, preferably double-acting, capable of using hydraulic energy to both retract and extend; a hoisting steel cable 40; a set of cable steering pulleys 50a, 50b, 50c; a hoisting hook 60 and a belt 70. Further, in accordance with embodiments of the present invention, the hoisting structure 100 comprises two drive receptacles 80, each associated with one of the hoisting systems 90, and mounted on the upper portion of each vertical beam 10.

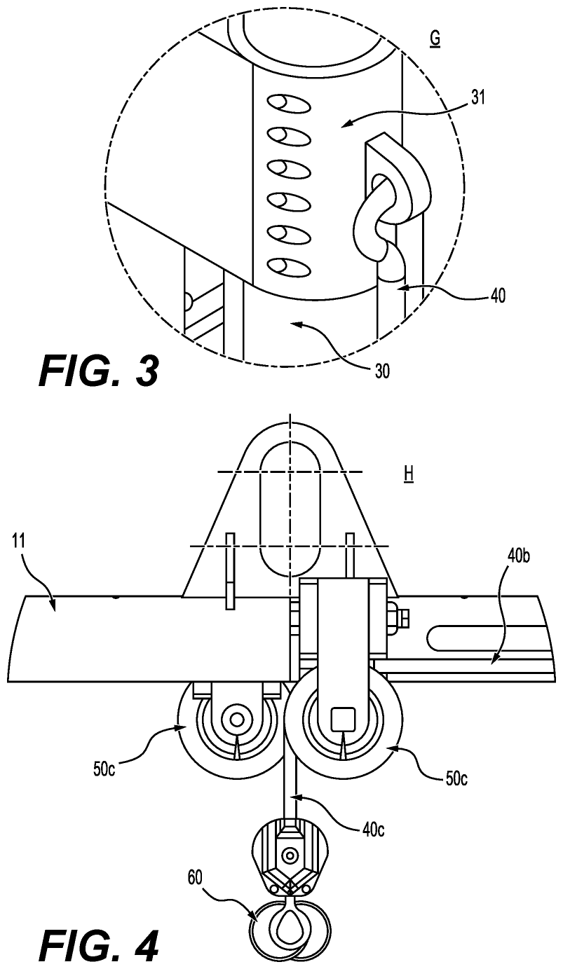

In this way, each hydraulic cylinder 30 is driven by means of an ROV (not shown) that connects a hot stab to the interface of the drive receptacle 80 to actuate the movement of the cylinder 30 in a controlled manner. According to embodiments of the present invention, as seen exemplarily in FIGS. 1 and 2, and in detail “G” of FIG. 3, one of the two ends of the hoisting steel cable 40 is attached to a fixing element 31 mounted on the hydraulic cylinder 30.

Thus, the activation of the hydraulic cylinder 30 by means of the ROV via hot stab of the hoisting structure 100 causes the cylinder 30 to advance, extending a first vertical run section 40a of the steel cable 40. A first steering pulley 50a is fixedly disposed at the lower end of the hydraulic cylinder 30 and on the fixing shoe 20, with the function of transmitting load and movement between two vertical paths of the first vertical run section 40a of the steel cable 40.

Additionally, the set of steering pulleys 50a, 50b, 50c of each hoisting system 90 further comprises a second steering pulley 50b fixedly mounted on the horizontal beam 11, closer to its end, and configured to transmit load and movement between a vertical path of the first vertical run section 40a of the steel cable and a horizontal path of a horizontal run section 40b of the hoisting steel cable.

Furthermore, according to some embodiments of the present invention, each hoisting system 90 further comprises a third steering pulley 50c of the set of pulleys 50a, 50b, 50c fixedly mounted on the horizontal beam 11, substantially centered in relation thereto and spaced horizontally relative to the second steering pulley 50b, wherein the third pulley 50c is configured to transmit load and movement between the horizontal path of the horizontal run section 40b of the steel cable and a vertical path of a second vertical run section 40c of the steel cable.

In accordance with embodiments of the present invention, a hoisting hook 60 is mounted at the other end of the two ends of the hoisting steel cable 40, the hook 60 being configured to receive and suspend a belt 70 wrapped around a region pipeline connection. Particularly, in relation to this process, in some embodiments of the present invention, an ROV or diver can be used to connect the belt 70, previously passed around the pipeline, to the hook 60 and, thus, perform the controlled hoisting of the pipeline by actuating the hydraulic cylinder 30. In this way, the pipeline is hoisted from the seabed and remains at an appropriate height from the ground to continue the connection or opening operation of lines.

After carrying out the operation and the pipeline hoisting maneuver, the ROV actuates the hydraulic cylinder 30 through a hot stab connected to the receptacle 80, so that the cylinder 30 moves in the opposite direction to the direction to pull the steel cable 40, thus relaxing the tension on the cable and loosening the same to release the belt 70 from the pipeline that was hoisted.

The present invention further provides a method for hoisting pipelines. Using the method of the present invention, it is possible to enable the complete operation of hoisting the pipeline for subsea connection or opening lines, depending on the application and design convenience.

Accordingly, according to an embodiment of the present invention, the pipeline hoisting method comprises: driving a drive receptacle 80 associated with a main hoisting system to vertically move a hydraulic cylinder 30; transmitting the load and movement through a hoisting steel cable 40 attached to the cylinder 30 at one of its ends and passing through a set of steering pulleys 50a, 50b, 50c; and hoisting the pipeline by means of a belt 70 wrapped around the pipeline and connected to a winch 60 arranged at the end of the steel cable. Additionally, according to an embodiment of the present invention, the method further comprises, in the event of failure of the main drive system, driving a drive receptacle associated with a secondary hoisting system to vertically move a hydraulic cylinder of the secondary hoisting system.

According to the method of the present invention, the driving of the drive receptacle is carried out by means of an ROV that connects a hot stab to the receptacle interface, pressurizing the hydraulic system of the ROV and allowing the cylinder to move.

As provided for by the present invention, one of its advantages lies in the redundancy of the hoisting systems that act independently of each other, allowing, in the event of failure in the drive cylinder or any other component on one side of the hoisting structure during the pipeline hoisting maneuver, an ROV can operate the structure through a secondary, or backup, hoisting system available on the opposite side of the structure, without the need of bringing the entire structure to the surface to perform the maintenance.

Still, as previously mentioned, another advantage of the present invention is the compact constructive form of the structure, which allows connecting or opening services of lines in a controlled manner by using, in some configurations, an additional containment system 200 (such as hoods) to support the hoisting structure 100, as shown exemplarily in FIG. 2.

Furthermore, FIG. 4 shows in detail a detail “H” of the third steering pulley 50c and the change from a horizontal path of the horizontal section 40b of the steel cable to a vertical path of the second vertical section 40c of the steel cable, according to an embodiment of the present invention. In this FIG. 4, there is shown, according to one of the embodiments of the present invention, a configuration wherein the axis of rotation of the third steering pulley 50c of a main hoisting system is not coincident with the axis of rotation of a third steering pulley 50c of a secondary hoisting system, positioned in the rear region of the horizontal beam 11. This configuration allows the second vertical sections 40c of the hoisting cables 40 to be parallel to each other, as well as the hooks 60 respectively associated with them, in order to facilitate the replacement of one system for another, if necessary.

Those skilled in the art will value the knowledge presented herein and will be able to reproduce the invention in the presented embodiments and in other variants, encompassed by the scope of the attached claims.

1. A pipeline hoisting structure, comprising three vertical beams joined together in a U-shape, and two hoisting systems, each being coupled to one of the vertical beams of the hoisting structure.

2. The structure according to claim 1, comprising a horizontal beam arranged in the upper portion of the structure and connecting with two of the three vertical beams.

3. The structure according to claim 2, wherein each of the three vertical beams is connected, at its lower end, to a fixing shoe that provides support and stability to the metallic structure on a seabed.

4. The structure according to claim 3, wherein each hoisting system of the two hoisting systems acts independently in relation to each other, wherein a first hoisting system of the two hoisting systems acts as the main hoisting system and a second system acts as a secondary hoisting system.

5. The structure according to claim 4, wherein each hoisting system comprises:
a hydraulic cylinder;
a hoisting steel cable;
a set of cable steering pulleys;
a hoisting hook); and
a belt.

6. The structure according to claim 5, further comprising two drive receptacles, each associated with one of the hoisting systems, and mounted on the upper portion of each vertical beam and configured to actuate a movement of the cylinder through connection of a hot stab in at least one drive receptacle by a remotely operated vehicle (ROV).

7. The structure according to claim 6, wherein one end of the steel cable is attached to a fixing element mounted on the hydraulic cylinder.

8. The structure according to claim 7, wherein the hydraulic cylinder is configured to extend a first vertical section of the steel cable when the hydraulic cylinder advances

9. The structure according to claim 8, wherein the set of steering pulleys comprises a first steering pulley fixedly disposed at the lower end of the hydraulic cylinder and on the fixing shoe, with the function of transmitting load and movement between two vertical paths of the first vertical section of the steel cable.

10. The structure according to claim 9, wherein the set of steering pulleys further comprises a second steering pulley fixedly mounted on the horizontal beam, closer to its end, and configured to transmit load and movement between a vertical path of the first vertical section of the steel cable and a horizontal path of a horizontal section of the hoisting steel cable.

11. The structure according to claim 10, wherein the set of steering pulleys further comprises a third steering pulley fixedly mounted on the horizontal beam, centered in relation to the same, and horizontally spaced in relation to the second steering pulley,
wherein the third steering pulley is configured to transmit load and movement between the horizontal path of the horizontal section of the steel cable and a vertical path of a second vertical section of the steel cable.

12. The structure according to claim 11, wherein the hoisting hook is mounted at the other end of the two ends of the hoisting steel cable, the hoisting hook being configured to receive and suspend the belt wrapped around a connection region of the pipeline.

13. The structure according to claim 6, wherein the ROV is configured to actuate on the hydraulic cylinder to tension or relax the steel cable.

14. The structure according to claim 1, further comprising an additional containment system to support the hoisting structure.

15. The structure according to claim 11, wherein an axis of rotation of the third steering pulley of a main hoisting system is not coincident with the axis of rotation of a third steering pulley of a secondary hoisting system.

16. A pipeline hoisting method, comprising:
driving a drive receptacle associated with a main hoisting system to vertically move a hydraulic cylinder;
transmitting a load and movement through a hoisting steel cable attached to an end of the cylinder and passing through a set of steering pulleys; and
hoisting a pipeline by a belt wrapped around the pipeline and connected to a winch arranged at the end of the steel cable.

17. The method according to claim 16, further comprising driving a drive receptacle associated with a secondary hoisting system to vertically move a hydraulic cylinder of the secondary hoisting system in case of failure of the main drive system.
